(19) United States
(12) Patent Application Publication
(10) Pub. No.: US 2003/0139988 A1
(43) Pub. Date: Jul. 24, 2003

(54) Method for deriving optimal income stream in intellectual asset transactions

(76) Inventor: Gavin Clarkson, Austin, TX (US)

Correspondence Address: Attn: Robert C. Curfiss, BRACEWELL & PATTERSON , L.L.P., P.O. Box 61389, Houston, TX, 77208-1389, US

(21) Appl. No.: 10/055,289

(22) Filed: Jan. 23, 2002

(51) Int. Cl. G06F 17/60

(52) U.S. Cl. 705/35

(57) ABSTRACT

The optimum royalty value of an intellectual asset is calculated using empirical data to determine an expected return on intellectual assets based on company history and industry averages (or medians). The value is calculated by determining the contribution to profit of intangible assets, deleting the contribution of assets other than intellectual assets from this contribution and deriving a base royalty rate from the difference. The contribution to profit of intangible assets may be based on publicly available information or on private company information. The method includes determining the weighted average of cost of capital in order to allocate the profits associated with intellectual assets.

### BACKGROUND OF THE INVENTION

1. Field of the Invention

The subject invention is related to a business method for determining the value of intellectual assets and is specifically directed to a business method for calculating and applying an optimum value to intellectual assets based on definable criteria.

2. Discussion of the Prior Art

The balance sheet of a successful company occasionally includes an entry for Intangible Assets. Given the microscopic level of study devoted to other elements of a company's financial statement, it is surprising to note the scant attention given to intangible assets. Nevertheless, the information economy includes numerous companies whose value is almost entirely based on intangible assets. More often than not, the value of these intangible assets is not reflected anywhere in a company's financial statements. Intellectual assets, a subset of intangible assets, are the main element in transactions that have become one of the most important aspects of our globally connected economy, accounting for “more than 20 percent of world trade, or approximately 740 billion US dollars,” see Lesley Ellen Harris, Digital Property: Currency of the 21st Century 51 (1998).

Despite the importance of intellectual asset transactions, it would seem they are often the least understood of all types of economic transactions, and perhaps the most poorly managed. A closer look at the nature of intellectual assets may provide a better understanding of these transactions. Typically, intellectual property asset transactions, whether through licensing or sale, are base on the simple criteria “what the market will bear.” In a surprisingly large number of such cases, the fees based on this method result in the seller/licensor either giving away too much or to the contrary, setting the fee so high that it is impossible for the purchaser/licensee to compete. The normal formulas for determining an accurate cost/value model do not apply to such transactions. For example, a manufacturer will typically set its end price for a product base on a multiplier applied to the cost of goods and overhead costs associated with the product. These costs are definable and various industries have fairly set multipliers. Thus, the manufacture can determine whether a product is going to be competitive based on fairly rigid mathematical models. This does not apply to intellectual assets. There are not any set methods for determining the value added to goods or services based on the costs associated with developing the asset.

Although some of the most important elements of a knowledge-based economy in the coming century will be intellectual asset transactions, the current marketplace for intellectual asset transactions is murky at best. With patent litigation costs skyrocketing, most organizations have only recently begun licensing and cross-licensing their intellectual asset portfolios. Because robust valuation metrics for intellectual assets have not been fully developed, most licensing negotiations are based on rules of thumb rather than quantitative methods, rules of thumb that can often be economically disadvantageous to either the licensee or the licensor. As stated in an article by John Milward, Earning It: A Five-Year Journey to a Better Mousetrap, N.Y. Times, May 24, 1998, 3, at 8, only two percent of the millions of innovations created in this country utilized under license, billions of dollars worth of intellectual assets are underutilized.

Economic theory suggests that the information necessary for quantitative analysis is too costly to acquire (i.e. difficult to obtain or not available at all), resulting in a relatively small number of market transactions involving intellectual assets, with valuations generally covered by rules of thumb. Different organizational behavior theories would probably suggest that some forms of bounded rationality are responsible for the use of these rules of thumb. The true answer probably lies somewhere in the middle of the spectrum between those perspectives.

What is needed is a better set of metrics for informing the parties to an intangible asset licensing negotiation so that the parties can increase the likelihood of concluding with a successful technology licensing agreement. Much of the previous economic literature on licensing, while theoretically sound, is neither empirically based nor instructive on how to develop an industry-based metric for royalty rates. See, for example: Nancy T. Gallini, Deterrence by Market Sharing: A Strategic Incentive for Licensing, The American Economic Review, December 1984, at 931; Nancy T. Gallini & Ralph A. Winter, Licensing in the Theory of Innovation, The Rand Journal of Economics, Summer 1985, at 237; Michael L. Katz & Carl Shapiro, On the Licensing of Innovations, The Rand Journal of Economics, Winter 1985, at 504; Michael L. Katz & Carl Shapiro, How to License Intangible Property, The Quarterly Journal of Economics, August 1986, at 567; Morton I. Kamien & Yair Tauman, Fees Versus Royalties and the Private Value of a Patent, The Quarterly Journal of Economics, August 1986, at 471.

The literature on patents, R&D expenditures, and market value is also informative, but does not provide clear guidance for examination of actual royalty rate provisions. Significant literature exists regarding economic examination of patents, patent counts, comparisons of patents and R&D, and evaluating returns from intellectual assets. See, for example: Jacob Schmookler, Economic Sources of Inventive Activity, The Journal of Economic History, March 1962, at 1; F. M. Scherer, Firm Size, Market Structure, Opportunity, and the Output of Patented Inventions, The American Economic Review, December 1965, at 1097; C. T. Taylor & Z. A. Silberston, The Economic Impact of the Patent System: A Study of the British Experience (1973); Zvi Griliches, et al., The Value of Patents as Indicators of Inventive Activity, in Economic Policy and Technological Performance 97 (Partha. Dasgupta & Paul. Stoneman eds., 1987); Zvi Griliches, Patents: Recent Trends and Puzzles, 1989 Brookings Papers on Economic Activity 291; Zvi Griliches, Patent Statistics as Economic Indicators: A Survey, Journal of Economic Literature, December 1990, at 1661; Research and Development, Brookings Papers on Economic Activity 783 (1987); Zvi Griliches, et al., R&D, and Patents, and Market Value Revisited: Is There a Second (Technological Opportunity) Factor? 1 Economics of Innovation and New Technology 183 (1991); Bronwyn H. Hall, Innovation and Market Value (Ray Barrell, et al. eds., 1998); Zhen Deng, et al., Science and Technology as Predictors of Stock Performance, Financial Analysts Journal, May/June 1999, at 20; Bronwyn H. Hall, et al., Market Value and Patent Citations: A First Look (National Bureau of Economic Research NBER Working Paper No. 7741, 2000); Ariel S. Pakes, On Patents, R&D, and the Stock Market Rate of Return, The Journal of Political Economy, April 1985, at 390; Richard C. Levin, et al., Appropriating the Returns from Industrial First Look (National Bureau of Economic Research NBER Working Paper No. 7741, 2000).

However, other than a small number of empirical studies, there has been little or no in-depth examination of royalty rate calculations. See Taylor & Silberston, The Economic Impact of the Patent System: A Study of the British Experience; Richard E. Caves, et al., The Imperfect Market for Technology Licenses, Oxford Bulletin of Economics and Statistics, August 1983, at 249; M. D. Rostoker, PTC Research Report: A Survey of Corporate Licensing, 24 IDEA 59 (1983); Inés Macho-Stadler et al., The Role of Information in Licensing Contract Design, 25 Research Policy 43 (1996); Ashish Arora, Patents, Licensing, and Market Structure in the Chemical Industry, 26 Research Policy 391 (1997); Stephen A. Degnan & Corwin Horton, A Survey of Licensed Royalties, Les Nouvelles, June 1997, at 91; Christian Bessy & Eric Brousseau, Technology Licensing Contracts Features and Diversity, International Review of Law and Economics, December 1998, at 451; Bharat N. Anand & Tarun Khanna, The Structure of Licensing Contracts, The Journal of Industrial Economics, March 2000, at 103.

Several authors, as well as jurists, however, have suggested to varying degrees that a good, industry-specific metric for use in royalty rate negotiations would be based on the aggregate earnings rates from companies with intellectual asset portfolios less the aggregate earnings rates from companies without such portfolios. See, for example Georgia-Pacific Corp. v. U.S. Plywood Corp., 318 F. Supp. 1116 (S.D.N.Y. 1970); TWM Mfg. Co., Inc. v. Dura Corp., 789 F.2d 895 (Fed. Cir. 1986); Gordon V. Smith & Russell L. Parr, Valuation of Intellectual Property and Intangible Assets (1994); Russell L. Parr & Patrick H. Sullivan, Technology Licensing: Corporate Strategies for Maximizing Value (1996); Lauren Johnston Stiroh & Richard T. Rapp, Modern Methods for the Valuation of Intellectual Property, 526 PLI/Pat 171 (1998); Richard S. Toikka, Patent Licensing Under Competitive and Non-Competitive Conditions, Journal of the Patent and Trademark Office Society, April 2000, at 279.

Smith & Parr and Parr & Sullivan in particular have suggested that such a metric could be derived from the well-established financial measure known as the Weighted Average Cost of Capital, but a specific metric has never been reduced to a workable form.

The difficulty of measuring and valuing innovation as embodied in a company's intellectual assets becomes particularly apparent when a company wants to acquire another company or the rights to exploit its intellectual assets. In the absence of a standardized marketplace for intellectual assets, a company might not even be aware that it has an intellectual asset that is valued by another company. Even organizations that are aware of their intellectual assets may tend to choose royalty rates based on a rule of thumb rather than rates based on quantitative metrics or analyses of profitability. Before examining quantitative methods that can be employed to calculate royalty rates, it is necessary to explore the nature of intellectual asset transfers.

Unlike real estate, a given intellectual asset can be “sold” many times and to multiple entities at the same time and for use in different places at the same time. This range of possibilities gives rise to a multitude of options for transferring rights to an intellectual asset. In general, rights can be either licensed or sold outright. A “licensor” exacts from a “licensee” a fee for the right to exploit in a defined way an asset to which the former retains ownership. In a sale, sometimes referred to as an assignment, the asset is transferred to a new owner. Owing to the uncertain absolute value of intellectual assets, licensing is far more common than sale.

Intellectual asset rights for a technology can be licensed individually or aggregated and licensed as a bundle. Licensing can be either exclusive (to only one licensee) or nonexclusive (to potentially multiple licensees). Exclusivity can be further limited by the scope of a license, which can be restricted geographically or by field of use. Additionally, licensees might be permitted to sublicense the rights to a technology and appropriate the benefits derived therefrom. Moreover, “most favored nation” status can guarantee specific licensees better terms and conditions than are granted to other licensees.

Although quite different, the licensing of intellectual assets is still somewhat analogous to a real estate lease. The owner retains ownership of the property and assigns certain rights to another party for a defined period of time and in return receives certain compensation, monetary or otherwise. The similarity ends rather abruptly, however, when the task turns to determining what the compensation should be, particularly if it is solely monetary. Tom Arnold, one of the original founders of the Licensing Executives Society (LES), aptly described licensing as follows:

“The licensing process is an art practiced in negotiation between two or more parties. The process is frequently difficult since its success requires that the parties agree on the exploitation of often highly valuable intellectual property rights in which both have, claim or want an interest. The range of interests, intellectual property rights, and exploitation arrangements is limitless, making the process of negotiating a mutually desirable agreement from the myriad possibilities indeed an art.” See, Tom Arnold, Basic Considerations in Licensing, Les Nouvelles, September 1980.

However “artistic” the negotiation of a license, the result is an agreement that affects both parties economically. More common than a lump sum license payment for a technology, particularly an unproven technology, is the negotiation of a royalty rate or contingent license fee on future earnings. The negotiation literature clearly indicates a strong theoretical basis for using contingent contracts for transactions with high degrees of uncertainty. See, Max H. Bazerman & Margaret A. Neale, Negotiating Rationally (1992); Max H. Bazerman, Judgment in Managerial Decision Making (1998); Max H. Bazerman & James J. Gillespie, Betting on the Future: The Virtues of Contingent Contracts, Harv. Bus. Rev., September-October 1999.

Further, the few empirical explorations of technology licensing agreements have found a high incidence of contingent contracts. See, Taylor & Silberston, The Economic Impact of the Patent System: A Study of the British Experience; Caves, et al., The Imperfect Market for Technology Licenses; Intellectual Property Research Associates, The Royalty Rate Report for Pharmaceuticals & Biotechnology, 3rd Edition (1996); Bessy & Brousseau, Technology Licensing Contracts Features and Diversity; Anand & Khanna, The Structure of Licensing Contracts.

If a lump sum arrangement is used, either instead of or in addition to a royalty rate, the amount of the payment is usually based on the present value of a stream of royalty payments. The challenge in any of these transactions is thus to determine what the appropriate royalty rate should be. The rate should approximate, as nearly as possible, the fair rate of return on the intellectual asset rights that are to be transferred.

In order to look for ways to improve the marketplace for intellectual asset transactions, it is first necessary to examine possible explanations for how the present situation arose and why it has not corrected itself on its own. An economic perspective contributes at least three elements that are helpful in understanding the present situation in intellectual asset transactions. First, the property rights view of the firm is a good starting point for examining the arena of intellectual assets themselves. Second, certain economic explanations for why firms organize are helpful in understanding why firms internalize innovative activity rather than seeking to license innovations from outside. It is the third set of ideas, transaction cost theory, that lends the most insight into why rules of thumb are used rather than quantitative methods for determining licensing rates in intellectual asset transactions: information is expensive and has historically been difficult, if not impossible, to obtain regarding the value of intellectual assets.

The economic view of the firm as a collection of property rights has particular relevance in the arena of intellectual asset transactions. The basic premise for this view is that the right to control the usage of an asset “resides with the owner of the asset. Ownership of an asset goes together with the possession of residual rights of control over that asset, that is, the owner has the right to use the asset any way that is not inconsistent with a prior contract, a custom, or any law” (Oliver D. Hart, An Economists's Perspective on the Theory of the Firm, in Organization Theory 154, at 160, Oliver E. Williamson ed., 1995). Furthermore, the property rights view of the firm specifically includes intellectual assets such as patents and copyrights. The resulting theory is that in a world of transaction costs and incomplete contracts, ex-post residual rights of control are important because, through their influence on asset usage, they affect ex-post bargaining power and the division of ex-post surplus in a relationship. It is that division of ex-post surplus from intellectual assets transactions that is of interest.

Economic theory has also contributed insight into why technology licensing has historically been somewhat rare relative to the level of innovation. Since there has not been much of a marketplace for intellectual asset transactions in the past, the best way for an organization to obtain intellectual assets was to create them internally rather than try to license them from an external organization. This premise is bolstered by the fact that intellectual asset transactions are not entirely understood by the average manager, in part because they are “legal” in nature.

Since most intellectual asset transactions are licenses for future royalty payments, it becomes easier to understand the historically small level of market transactions for intellectual assets.

Similarly, because licensing negotiations eventually require decisions on whether or not to agree and if there is insufficient information to comfortably support those decisions, the number of such transactions taking place in the market will be small. Bargaining and negotiation are complex activities, requiring knowledge of one's own interests and priorities, those of others, information about the current and likely future states of affairs, knowledge of rule systems and norms governing agreements, and related matters. The gathering of information is also essential to arriving at a decision. Thus, absent sufficient information, such negotiations are unlikely to conclude satisfactorily, if they take place at all, without resorting to a rule of thumb which does not require the same level of information as would a quantitative analysis.

More specifically it is difficult to obtain the fair market value (FMV) of the various rights to the intellectual assets involved in the intellectual asset transaction. In general, the FMV is the price at which an asset would trade between two rational individuals, each in command of all of the information necessary to value the asset and neither under any pressure to trade. Relating this concept to royalty rates, courts have often used a variation of FMV in the form of a “willing buyer and willing seller” rule in an attempt to calculate patent infringement damages. The difficulties lie in the fact that intellectual asset valuations are not easy to obtain, unlike parcels of real estate, where market comparables give a fairly close approximation of the FMV of a piece of land. Because intellectual assets are often innovative, it is difficult if not impossible to find one market comparable transaction that can be used to assist in valuing another transaction. In general, the market approach measures the present value of future benefits by obtaining a consensus of what others in the marketplace have judged it to be. There are two requisites: 1) an active, public market, and 2) and exchange of comparable properties. Unfortunately, the two requisites rarely exist for a sufficiently strong estimate of value of intellectual assets.

Cost basis valuations are usually not very helpful either. The cost approach attempts to measure the future benefits of the license of a technology by quantifying the investment that would be required to replace the future service capability of the technology, frequently referred to as replacement cost. Often the cost approach is a very conservative, if not a poor, indication of value because a company can invest very little in technology and invent something with value that greatly exceeds cost. One such example of a breakthrough technology would be Post-It® Notes, which 3M introduced in 1980. This simple invention cost 3M very little to develop, but 3M has reaped huge profits off an entire line of products based on the original invention.

The third method, the income approach, is based on the premise that the FMV of an intellectual asset (or any asset for that matter) can be expressed as the present value of the anticipated stream of economic benefits that can be secured by ownership of the asset. In essence, this approach examines the income producing capability of an intellectual asset in determining its value. The three main questions answered by the income approach are:

What is the income stream that will be generated over time by the intellectual asset?

How long will that stream last?

What is the likelihood (risk) that the forecasted income stream will materialize?

In addition to the fact that the income approach is not readily understood by managers when applied to intellectual assets, if nothing else, it is clear to see from these three questions that the income approach is rife with uncertainty and speculation absent some form of robust metrics. Thus the view of the environment for intellectual asset transactions is clearly one of cognitive limitations with high levels of uncertainty and complexity that encourage individuals to move the affected transactions out of markets and into organizations, and to use rules of thumb for the remaining market transactions.

Additionally, the organizational behavior perspective not only sheds light on why a single firm might “satisfice” by choosing a rule of thumb for an intellectual asset transaction, it also helps explain why such rules of thumb become commonplace via organizational conformity. These rules of thumb in intellectual asset transactions are in use in the current marketplace because their initial use and subsequent lack of preferable alternatives entrench them as the methods of choice in the marketplace: “We do it this way because this is the way we have always done it, and this is how everyone expects it to be done in the industry.”

### SUMMARY OF THE INVENTION

The subject invention is directed to a method for calculating the optimum royalty value of an intellectual asset by using empirical data to determine an expected return on intellectual assets based on company history and/or industry averages. The value is calculated by determining the contribution to profit of intangible assets, deleting the contribution of assets other than intellectual property from this contribution and deriving a base royalty rate from the difference. The contribution to profit of intangible assets may be based on publicly available information or on private company information. The method includes determining the weighted average of cost of capital in order to allocate the profits associated with intellectual assets.

The method is a quantitative approach for determining asking price and involves the use of generally publicly available industry information together with basic financial formulas to determine the contribution to profit of intellectual assets. Expressed as percentage of sales, this result can be used as a starting point for royalty rate negotiations or as a “reality check” for royalty rates determined by other means.

This method is premised on the notion that the licensor should be able to extract from the licensee a royalty stream that is comparable to its own return on intellectual property and intellectual assets (IPIA). Alternatively, a licensor can look to its industry for average return on IPIA. Since returns on intellectual assets are not normally being reported in company financials, it is necessary to derive them from the data that is available. An industry average contribution to profit from intellectual property and intellectual assets (CPIPIA) can be derived from annual reports and other publicly available information. Before a measure for intellectual assets can be derived, however, the contribution to profit of intangible assets (CPIA), which includes intellectual assets, must be derived. Once CPIA is determined, the calculation of CPIPIA is straightforward.

The invention permits one to calculate realistic royalties rather than “rely” on the unreliable rules-of-thumb of the prior art, based on culture and tradition rather than empirical data.

### DESCRIPTION OF THE PREFERRED EMBODIMENT

Intellectual asset transactions will always, by nature, be complex and be subject to uncertainty and risk; thus the increase in information availability will be critical to any increase in transactional efficiency or numerosity. But if the organization has sufficient information processing systems or metrics then the organization's scarce attention can be focused on optimizing the intellectual asset transaction because the “information systems are designed and created to provide the information that the decision maker requires.” (Jeffrey Pfeffer & Gerald R. Salancik, The External Control of Organizations: A Resource Dependence Perspective, p. 75 (1978)).

The subject invention is directed to a quantitative approach for determining asking price and involves the use of publicly available industry information together with basic financial formulas to determine the contribution to profit of intellectual assets. Expressed as percentage of sales, this result can be used as a starting point for royalty rate negotiations or as a “reality check” for royalty rates determined by other means.

This method is premised on the notion that the licensor should be able to extract from the licensee a royalty stream that is comparable to its own return on intellectual property and intellectual assets (IPIA). Alternatively, a licensor can look to its industry for average return on IPIA. Since returns on intellectual assets are not normally being reported in company financials, it is necessary to derive them from the data that is available. An industry average contribution to profit from intellectual property and intellectual assets (CPIPIA) can be derived from annual reports and other publicly available information. Before a measure for intellectual assets can be derived, however, the contribution to profit of intangible assets (CPIA), which includes intellectual assets, must be derived. Once CPIA is determined, the calculation of CPIPIA is straightforward.

The CPIA metric is, in essence, an expression of the percentage of a company's profits that are due to its intangible assets as opposed to its monetary assets (i.e. cash and liquid securities on hand) or tangible assets (i.e. property, plant and equipment). CPIPIA is derived in a given industry by subtracting the average (or, alternatively, the median) CPIA value for distributors from the CPIA value for a given manufacturer or a portfolio of manufacturers. For those more familiar with corporate finance, the remainder of this section describes the derivation of CPIA and the resulting CPIPIA.

The first metric (CPIA) is based on the existence of two formulations of the Weighted Average Cost of Capital (WACC). The traditional formulation of WACC is

WACC=E(Ri)+D(Ri)=Rf+β×E(Rp)+i×(1−t)

where

E(Ri)=expected rate of return for equity investors

D(Ri)=expected rate of return for debt investors

Rf=risk free rate of return

β=beta or systematic risk

E(Rp)=expected risk premium

i=interest rate on debt

t=effective federal and state tax rate.

The theoretical underpinnings of WACC, however, are based on the idea that a company's cost of capital is the cost of the individual sources of capital, weighted according to their importance in the firm's capital structure. WACC can thus be broken down into its relative components,

Return on monetary assets: Rm

Return on tangible assets: Rt

Return on intangible assets: Ri

and be represented as a weighted average of the required return from monetary, tangible, and intangible assets:

$$WACC = \frac{{V}_{m}}{{V}_{bev}} {R}_{m} + \frac{{V}_{t}}{{V}_{bev}} {R}_{t} + \frac{{V}_{i}}{{V}_{bev}} {R}_{i}$$

where Vₘ, Vₜ, and Vᵢ are the fair market values of the monetary, tangible, and intangible assets, respectively, and V_{bev} is the fair market value of the business enterprise, which is the total of Vₘ, Vₜ, and Vᵢ.

Solving for

$$\frac{{V}_{i}}{{V}_{bev}}$$

Ri (or R_{iw}), the weighted rate of return on intangible assets, results in:

$$\frac{{V}_{i}}{{V}_{bev}} {R}_{i} = WACC - \frac{{V}_{m}}{{V}_{bev}} {R}_{m} - \frac{{V}_{t}}{{V}_{bev}} {R}_{t} = {R}_{iw}$$

and the unweighted rate of return on intangible assets, Ri is:

$${R}_{i} = \frac{WACC - \frac{{V}_{m}}{{V}_{bev}} {R}_{m} - \frac{{V}_{t}}{{V}_{bev}} {R}_{t}}{\frac{{V}_{i}}{{V}_{bev}}}$$

Using balance sheet and income statement data as well as the 3-month T-Bill for Rₘ and the 10-year T-Bond for Rₜ, the calculation of the respective weighted returns for monetary and tangible assets is possible. As shown above, subtracting those values from WACC yields the weighted rate of return for intangible assets.

To obtain the return on intangibles as a percentage of the total cost of capital, R_{iw} is divided by the previously derived WACC value. Multiplying this value by Debt Free Net Income (“DFNI”) results in the contribution to profit by intangible assets expressed in dollar terms.

DFNI=NI+InterestExpense(1−tax)

Dividing that value by sales gives us CPIA expressed as a percentage.

$$CPIA = \frac{\frac{{R}_{iw}}{WACC} DFNI}{Sales}$$

This calculation can be repeated for all of the companies in an industry to arrive at an average CPIA.

Because CPIA still includes the contribution to profit of intangible assets other than intellectual property and intellectual assets (IPIA), these non-IPIA elements must be filtered out in order to arrive at a CPIPIA that can then be used as the licensor's starting point for royalty rate negotiations. In a given industry, some companies might have strong IPIA portfolios and other, equally well-run companies lack IPIA. Subtracting an industry average (or median) for CPIA for companies without IPIA from the CPIA value for a company with an IPIA portfolio, or an industry average (or median) for companies with IPIA portfolios, yields a value for CPIPIA, the contribution to profit of both intellectual property and intellectual assets for a given company or industry.

Although not an exact measure of a company's intellectual asset value, CPIPIA is a good, industry-based approximation. As a starting point for royalty rate discussions, it has verisimilitude by virtue of its basis in a WACC calculation that is specific to the company in question. However, since the CPIPIA metric is based on hypothesized behavior of CPIA, that behavior must be demonstrated before any further exploration of CPIPIA is warranted.

The main underlying assumption in the CPIA metric is that CPIA values will be higher for companies with larger intangible asset portfolios and be lower for companies with little or no intangible assets.

Regression Analysis

The first measure to examine is R&D expenditures. Assuming that certain companies in the subject industry engage in R&D to increase their portfolios of intangible assets while others are merely distributors, a positive correspondence between R&D expenditures and CPIA values should exist as well as a positive correspondence to manufacturer/distributor classification. Specifically, as a firm's R&D expenditures increase as a percentage of sales, so will its contribution to profit of intangible assets increase as a percentage of sales. Similarly, since manufacturers generally engage in more R&D relative to sales volume than do distributors, if CPIA behaves as expected, distributors will have lower CPIA values than manufacturers.

Using the methodology of the subject invention, one can test the theory against the null hypothesis Ho: β₁=0 and β₂=0 by calculating CPIA as follows:

CPIA=β₀+β₁*RDSALES+β₂*SIC

where RDSALES is R&D expenditure expressed as a percentage of sales, and SIC is an indicator variable, 1 for manufacturers and 0 for distributors.

The regression results, summarized in Table 1, explain more than half of the variance in CPIA and indicate that there is a significant, positive relationship (β₁=0.539, p<0.001) between R&D expenditures as a percentage of sales and CPIA, as well as a significant correspondence between manfacturer/distributor status and CPIA (p=0.001).

TABLE 1
Regression Results for CPIA RDSALES, and SIC

| Source | SS | df | MS |
|---|---|---|---|
| Model | .346209023 | 2 | .173104512 |
| Residual | .295076552 | 55 | .005365028 |
| Total | .641285576 | 57 | .011250624 |

Number of obs = 58
F(2, 55) = 32.27
Prob > F = 0.0000
R-squared = 0.5399
Adj R-squared = 0.5231
Root MSE = .07325

| CPIA | Coef. | Std. Err. | t | P >\|t\| | [95% Conf. Interval] | |
|---|---|---|---|---|---|---|
| RD- | .5391483 | .0908553 | 5.934 | 0.000 | .3570702 | .7212263 |
| SALES | | | | | | |
| SIC | .0939723 | .0278601 | 3.373 | 0.001 | .0381395 | .1498052 |
| _cons | .0121287 | .0244155 | 0.497 | 0.621 | −.0368011 | .0610584 |

Application of CPIPIA Metric

Thus far the metric for calculating CPIA has been derived from publicly available market data. It has been verified that firms that engage in relatively higher levels of R&D as a percentage of sales have higher CPIA values, and has demonstrated that bifurcation into manufacturers and distributors is consistent with the behavior of CPIA. As a result, subtracting the average (or median) CPIA value for a group of distributors from the CPIA value for a given manufacturer results in a CPIPIA value that reflects contribution to profit of intellectual assets for the given firm. Subtracting the average (or median) distributor CPIA from the average (or median) manufacturer CPIA results in an industry CPIPIA.

The metric is useful in actual licensing transactions in at least two ways. The first use would be as a starting point for a royalty rate negotiation, and the second would be as a “sanity check” to validate a royalty rate derived through other quantitative means.

To determine CPIPIA for use as a starting point for an “average” company, start with a set of company data, such as that presented in the appendix and calculate CPIA for each company. Group the companies into low CPIA (i.e. distributors) and high CPIA (manufacturers), and calculate averages CPIA for each group.

To use CPIPIA to validate a royalty rate generated through other means, a confidence interval for CPIPIA can be calculated and then used to determine if the given rate falls within that interval. If not, it might be worth reexamining either the methodology used to derive the royalty rate or reevaluating the business case for granting the license. Even if a royalty rate seems low relative to the industry average CPIPIA, there may be other strategic reasons to enter into the licensing relationship whose benefits outweigh the economic difference between the license rate and the industry average CPIPIA.

As the knowledge economy expands, the knowledge marketplace for intellectual asset transactions will have to mature. In order to do so, the participants in the market must have a better understanding of the value of the assets involved in intellectual asset transactions. Using such quantitative metrics, it is premised that intellectual asset transactions can take place in a more informed manner. Licensors can enter the negotiations knowing what their industry generates as an average contribution to profit from intellectual assets that are exploited internally and can use that average as a starting price in terms of a royalty rate, with the range of intellectual asset profit contribution (CPIPIA) across the industry defining the feasible set of royalty rates. Alternatively, CPIPIA can be used as a “reality check” for license rates developed by other means. On the other side of the transaction, with an appropriate set of metrics, the licensee could enter the negotiations with a good idea of the range of royalty rates for which licensing the intellectual asset makes sense. The convergence of these two ranges creates a feasible set of win-win licensing scenarios and ensures that licensees enter into arrangements that make economic sense, and licensors do not leave money on the table. If there is no feasible set of win-win scenarios, the parties can then make an informed decision whether or not to look elsewhere for licensing possibilities. Such an arrangement increases the likelihood that an asset will be valued at its highest investment value.

While certain features and embodiments of the invention have been described in detail herein, it will be readily understood that the invention includes all modifications and enhancements within the scope and spirit of the following claims.

What is claimed is:

1. A method for calculating the optimum value of an intellectual asset comprising the steps of:
a. determining the contribution to profit of intangible assets;
b. deleting the contribution of assets other than intellectual assets from this contribution;
c. deriving a base royalty rate from the difference.

2. The method of claim 1, wherein the contribution to profit of intangible assets is based on publicly available information or private company information.

3. The method of claim 1, wherein the contribution to profit of intangible assets is based on an industry average (or median).

4. The method of claim 1, wherein the contribution to profit of intangible assets is calculated by first calculating the weighted average of cost of capital.

5. The method of claim 4, wherein the weighted average of cost of capital (WACC) is derived, using the following formula:
WACC=E(Ri)+D(Ri)=Rf+β×E(Rp)+i×(1−t)
where
E(Ri)=expected rate of return for equity investors
D(Ri)=expected rate of return for debt investors
Rf=risk free rate of return
β=beta or systematic risk
E(Rp)=expected risk premium
i=interest rate on debt
t=effective federal and state tax rate.

6. The method of claim 4, wherein the weighted average of cost of capital (WACC) is inserted into the following formula:
$$WACC = \frac{{V}_{m}}{{V}_{bev}} {R}_{m} + \frac{{V}_{t}}{{V}_{bev}} {R}_{t} + \frac{{V}_{i}}{{V}_{bev}} {R}_{i}$$
where
Rm is the return on monetary assets,
Rt is the return on tangible assets,
Ri is the return on intangible assets,
Vₘ, Vₜ, and Vᵢ are the fair market values of the monetary, tangible, and intangible assets, respectively, and
V_{bev} is the fair market value of the business enterprise, which is the total of Vₘ, Vₜ, and Vᵢ.

7. The method of claim 6, wherein the weighted return on intangible assets is Riw, and is calculated as:
$${R}_{iw} = \frac{{V}_{i}}{{V}_{bev}} {R}_{i} = WACC - \frac{{V}_{m}}{{V}_{bev}} {R}_{m} - \frac{{V}_{t}}{{V}_{bev}} {R}_{t} .$$

8. The method of claim 6, wherein the unweighted return on intangible assets is Rᵢ, and is calculated as:
$${R}_{i} = \frac{WACC - \frac{{V}_{m}}{{V}_{bev}} {R}_{m} - \frac{{V}_{t}}{{V}_{bev}} {R}_{t}}{\frac{{V}_{i}}{{V}_{bev}}} .$$

9. The method of claim 7, the contribution to profits of intangible assets (CPIA) is calculated based on debt free net income, which is expressed as:
DFNI: DFNI=NI+InterestExpense(1−tax),
and wherein the CPIA is express as a percentage, as follows:
$$CPIA = \frac{\frac{{R}_{iw}}{WACC} DFNI}{Sales} .$$

10. The method of claim 1, wherein the contribution to profit of intellectual assets (CPIPIA) is calculated by subtracting the industry average (or median) distributor CPIA from the CPIA value for a given firm.

11. The method of claim 1, wherein the contribution to profit of intellectual assets (CPIPIA) is calculated by subtracting the industry average (or median) distributor CPIA from the average (or median) manufacturer CPIA value for a given industry.
